(19) United States
(12) Patent Application Publication
(10) Pub. No.: US 2015/0159417 A1
(43) Pub. Date: Jun. 11, 2015

(54) DEVICE FOR LOCKING A MOVABLE COMPONENT

(71) Applicant: Strasser Maschinenbau GmbH, Berg (DE)

(72) Inventor: Karl-Heinz Strasser, Berg (DE)

(21) Appl. No.: 14/486,458

(22) Filed: Sep. 15, 2014

(30) Foreign Application Priority Data
Sep. 13, 2013 (DE) EP13184273.4

(51) Int. Cl. E05F 15/56; E06B 5/10; E05B 41/00; E05B 65/08; E05F 5/08; E05F 3/18

(52) U.S. Cl. CPC E05F 15/56; E05F 5/08; E05F 3/18; E05B 41/00; E05B 65/08; E06B 5/10

(57) ABSTRACT

An assembly for locking a movable protective door disposed in front of a point to be shielded, the device comprising
two rails extending parallel to one another, in which the door is guided and adjusted by a servo device,
a locking element interacting with a guide column extending parallel to the rails for locking the door, or a locking circuit by which the servo device can be deactivated,
and a contact strip attached to the door and in driving connection with the locking element, or electrically connected to the locking circuit,

advance speed of the door being adapted to be increased without violating statutory safety provisions for stopping the component,

wherein a recovery device is disposed between the contact strip and the door, and is in driving connection with the contact strip, such that when the contact strip makes contact with an obstacle protruding into the access point, the recovery device is activated by resistance of the obstacle, and the contact strip is moved in the direction of the component by the recovery device.

### BACKGROUND OF THE INVENTION

1. Field of the Invention

The present invention relates to a device for locking a movable component, in particular a protective, or sliding, door arranged in front of a working, or access, point to be shielded.

2. Description of the Prior Art

A locking device of this kind is disclosed in EP 2 562 464 A1, and is used for locking a component held in a movable arrangement between profile rails. For safety reasons, it is desirable for a working point on a machine tool, or an access area, for example, of an elevator, or a sliding door on a train, to be secured when an obstacle is introduced into the working, or access, area inadvertently, so as to avoid injuries or damage to the component in question, or the obstacle.

In order to achieve the locking of the component, especially a sliding or protective door, a guide column is provided extending parallel to the profile rails and interacting with a locking element in the locked condition of the component. The locking element encloses the guide column, in whole or in part, and is in a driving active connection with a contact strip mounted on the component in an articulated arrangement. If the contact strip encounters an obstacle when the component is advanced, mechanical connection elements activate the locking element by swivelling of the contact strip. The swivelling of the contact strip moves the mechanical connection elements out of their initial position to an end position, and this movement is passed onto the locking element, with the effect that it is moved from a position enclosing the guide column to a position that interacts with the guide column in a friction-locking arrangement. Consequently, a driving, or force-locking, active connection is created between the locking element and the guide column by means of which the component is reliably stopped, so as to avoid damage to the introduced obstacle or, in the event that a part of the human body is involved, injury is avoided.

Locking devices of this kind have proven effective in practice, although it has been revealed that such components can only be moved with a particular advance speed.

To exclude the possibility of damaging the obstacle introduced into the working or access point, it is necessary to stop the component with speed. As a result of the mechanical connection elements, there is a time lag between the first contact made by the contact strip with the obstacle and the actuation of the locking element. Furthermore, the locking element requires a certain length of travel to be covered along the guide column in order to exert sufficient force on the guide column so that the component will be stopped. However, the faster the component is advanced, the greater the distance covered by the component following first contact between the contact strip and the obstacle, as a result of which the danger of damage or injury is to considerably increased.

### SUMMARY OF THE INVENTION

The object of the present invention is, therefore, to provide a device of the aforementioned type for locking a component at a significantly faster advance speed so that the movement of the component can be used without violating statutory safety provisions defined in standards for stopping or locking of the component.

Because there is a recovery device disposed between the contact strip and the component, and the recovery device is in a driving connection with the contact strip, when the contact strip makes contact with an obstacle protruding into the working or access point, the recovery device is deactivated by the resistance of the obstacle such that the contact strip is moved, or swivelled, in the direction of the component by the recovery device. A situation is achieved in which, firstly, the contact strip activates the locking device and the component is secured after a specific time and, secondly, sufficient space is made available before the contact strip, or the bottom edge of the component, strikes the obstacle. As a result, the distance between the bottom edge of the component and an introduced obstacle is increased and there is more time available for the movement of the component to be stopped.

Furthermore, the length of time during which the contact strip remains attached to the component in a manner which allows it to move, or swivel, is increased, meaning that the activation of the recovery device actively pulls the contact strip back from the danger zone represented by an obstacle. Also, when the contact strip is attached to the component in a way that allows it to move in a linear direction, the contact strip can be pulled back from the danger area in the direction of the component by means of the recovery device, because the recovery device is able to achieve a faster recovery movement for the contact strip than the prevailing advance speed of the component.

It is advantageous for the recovery device to incorporate a pull rod attached to the contact strip and to the component, with the effect that when the component is in the usual actuation status there are no relative movements between the recovery device and the component, because the recovery device is permanently moved together with the component. Furthermore, the recovery device features a pre-stressed coil compression spring (or another energy storage element) which is arranged between a sliding block and the contact strip. The sliding block in this case is mounted in a detent seat. As soon as the contact strip encounters an obstacle, a force is transmitted via the contact strip and the pull rod to the sliding block, as a result of which it is moved out of the detent seat. The preload force of the coil compression spring now causes the contact strip to be actively drawn in, or opposite to, the advance direction of the bottom edge of the component, and in a preferred embodiment this takes place at a speed that is faster than the advance speed of the component, as a result of which the contact strip is immediately moved to an underside, or bottom edge, of the component. This releases the space available between the bottom edge and the contact strip when the contact strip is actuated, in order to lock the component. At the same time, the dynamic mass of the contact strip is reduced.

### BRIEF DESCRIPTION OF THE DRAWINGS

The drawings show a sample embodiment configured in accordance with the present invention, the details of which are explained below. In the drawings,

FIG. 1A is a perspective now showing a device for locking a component moveable between two profile rails, on the underside of which a contact strip is provided, with a servo device by means of which the component is moved, and with a guide column by means of which the component is locked via a locking element in the event of actuation,

FIG. 1B is an elevational front view showing the device in accordance with FIG. 1A, in a non-actuated initial position,

FIG. 1C in an elevational front view showing the device in accordance with FIG. 1A, in an actuated status,

FIG. 2A in an elevational view showing a section of the device in accordance with FIG. 1B, with a recovery device, in a non-actuated status,

FIG. 2B illustrates the recovery device in accordance with FIG. 2A, on first contact between the contact strip and an obstacle,

FIG. 2C illustrates the recovery device in accordance with FIG. 2B, in actuated status of the contact strip,

FIG. 2D is a magnified view of the recovery device in accordance with FIG. 2A, with a detent seat, and a sliding block secured therein,

FIG. 3A is a magnified sectional view of the recovery device in accordance with FIG. 2A, in an alternative embodiment,

FIG. 3B illustrates the device in accordance with FIG. 1A, in which the recovery device is connected to the servo device,

FIG. 4A is a perspective view of the device in accordance with FIG. 1A,

FIG. 4B are elevational views of the device shown with FIG. 4A, and 4C

FIG. 5A are perspective views showing the device in accordance to 5D with FIG. 1A with differently embodied contour profiles for the contact strip and a bottom edge of the component.

### DESCRIPTION OF THE PREFERRED EMBODIMENTS

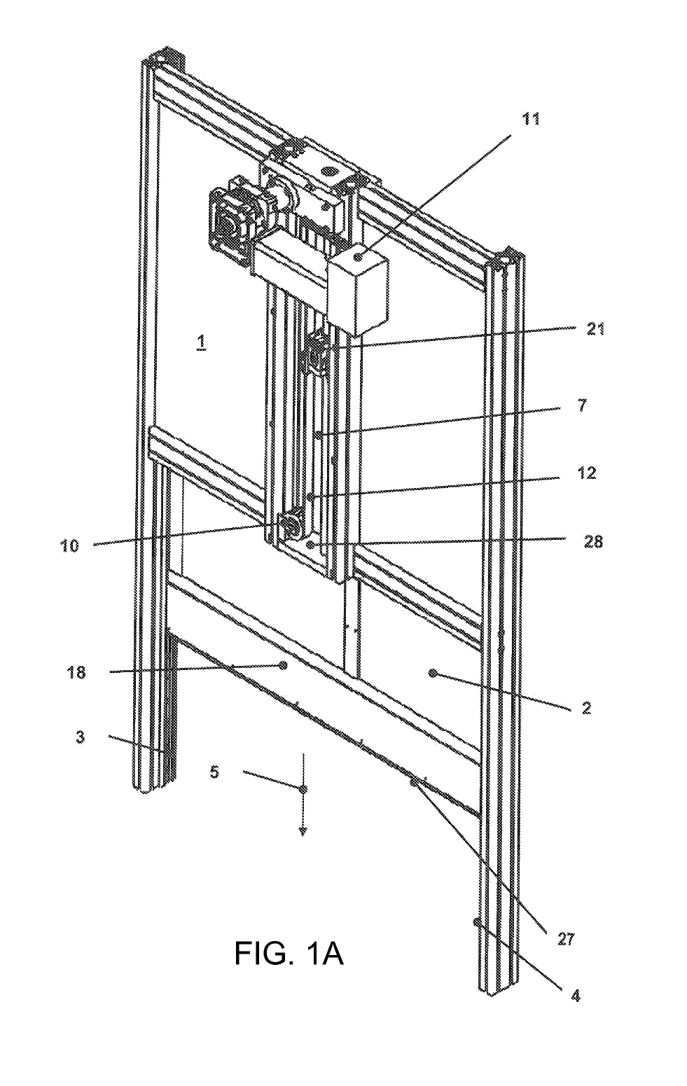

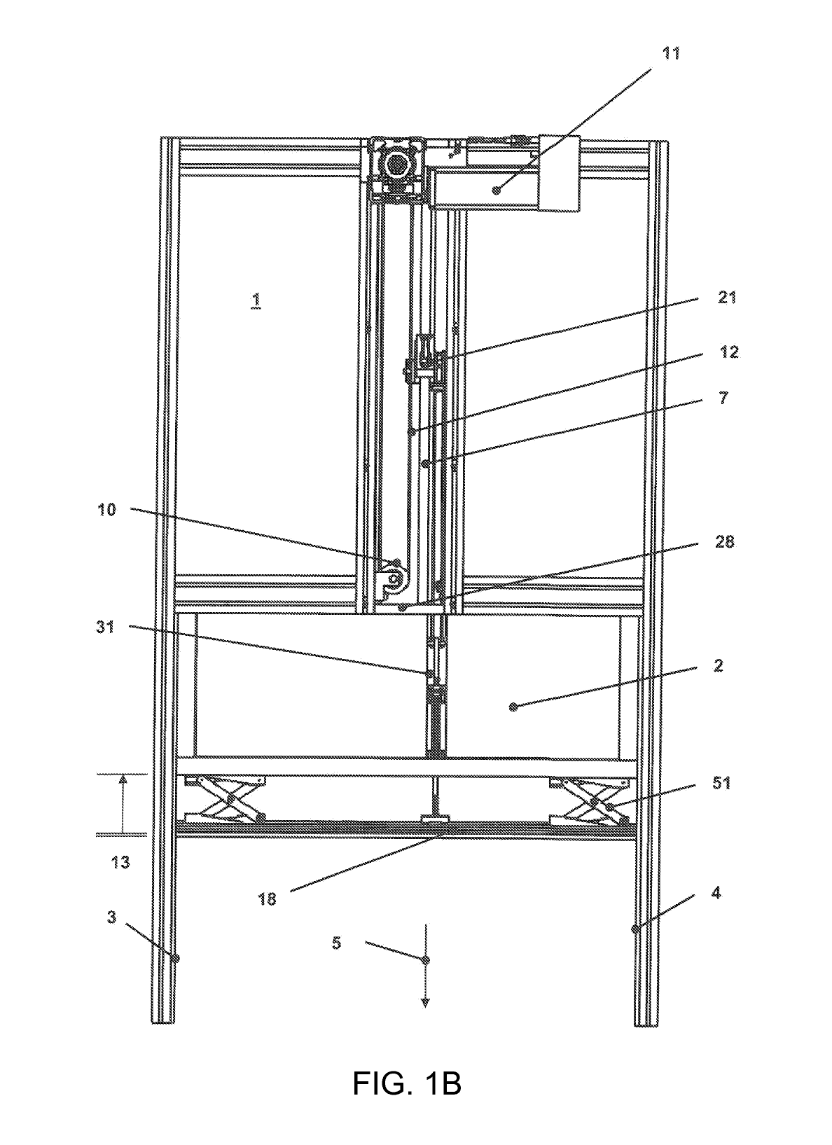

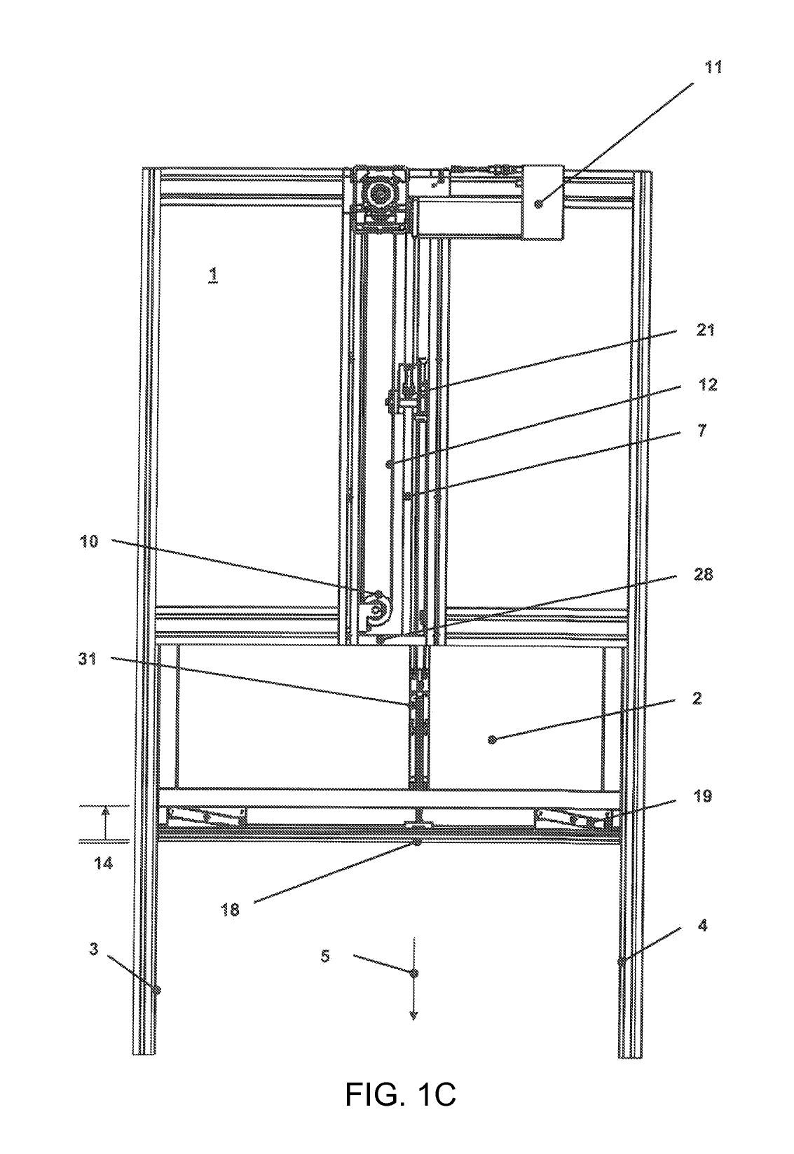

FIGS. 1 to 4C disclose a device 1 for locking a movable component 2, especially a sliding or protective door arranged in front of a working or access point of a machine, or an access, to be shielded. The component 2 moves in a vertical adjustment direction 5 in order to close off the working point on the machine-tool, on a conveyor belt, or another machine, from the outside during the machining process, as a result of which it is not accessible and is, to this extent, protected. It goes without saying that the component 2 can also be moved in the horizontal or a sloping plane if, for example, the entrance area at an access is to be closed, or for entry to the access.

For loading and unloading of the working point, it is necessary for the component 2 to be lifted opposite to the adjustment direction 5. For this purpose, the component 2 is held in two C or U-shaped profile rails 3 and 4 that are aligned in parallel to, and at a distance from, one another.

Furthermore, a servo device 11 is provided, for example, in the form of an electric motor, by means of which a V-belt 12 is driven. The device 1 is attached to the V-belt 12 in a specified position, and is thus in a driving connection with the V-belt 12 and the component 2. Consequently, rotation of the V-belt 12 causes the component 2 to move up and down in the profile rails 3 and 4. A reversing wheel 10 is provided in the area of a base 28 of the working point in this case, by means of which the V-belt 12 is guided and secured.

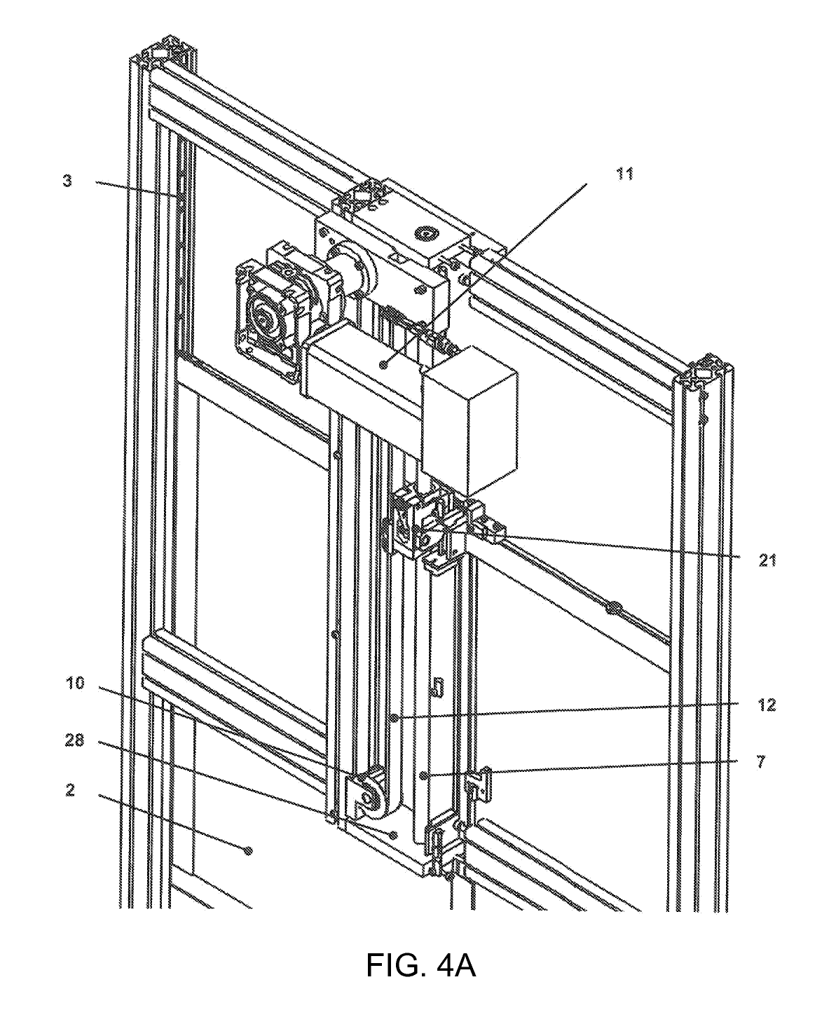

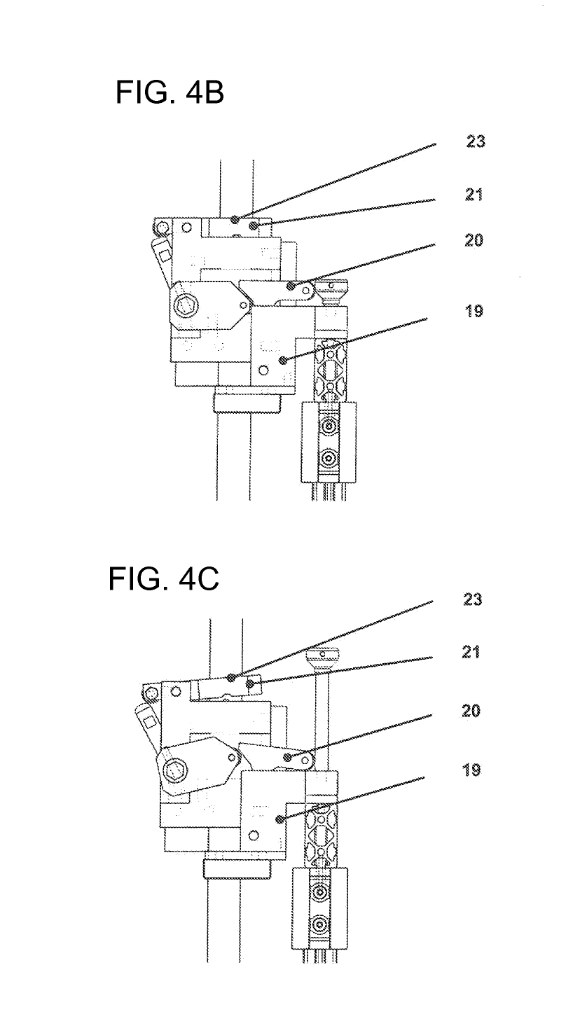

If, during the closing movement of the component 2, i.e., movement in the adjustment direction 5, a member of the operating personnel incorrectly operates the working point of the machine tool and, for example, reaches into it thereby generating an obstacle, his or her arm could be trapped by the movement of the component 2 between the component 2 and a closing edge 27, thereby injuring it. For safety reasons, the component 2 must therefore be stopped immediately if it encounters an obstacle during its adjustment movement downwards. For this purpose, a contact strip 18 is attached to the bottom edge of the component 2 and is mounted on the component 2 in such a way as to allow it to swivel outwards or move in the plane of the component 2, and the contact strip 18 has an angle rail 19 attached to it as a mechanical connection element, which is connected to a rocker 20. In this case, the rocker 20 is mounted in a swivelling arrangement on the device 1 and as soon as the contact strip 18 is pressed outwards or lifted in a linear direction, as shown in FIGS. 4A and 4B, the rocker 20 is pushed downwards and a locking element 21 of the device 1 is activated for locking the component 2. The locking element 21 in this case consists of a holding plate of a rectangular design that is worked into an opening 23.

A guide column 7 is provided in parallel to, and at a distance from, one or both sides of the profile rails 3 and 4, and the locking element 21 extends along the guide column 7 with play. Consequently, the opening 23 is almost completely filled by the guide column 7; however, the inside of the opening 23 does not make contact with the outside of the guide column 7 during the lifting movement of the component 2, as a result of which there is no contact in the normal operating status, and thus there is also no wear whatsoever on the guide column 7 or the inside of the opening 23.

If, however, the contact strip 18 is actuated and pushed outwards, or raised in a linear direction, this causes the locking element 21 to move such that the opening 23 is tilted out of the horizontal plane and thus, as is shown in FIGS. 4B and 4C, a force-locking active connection results between the guide column 7 and the locking element 21, which gives rise to a braking force by means of which the adjustment movement of the component 2 is stopped, and a braking force is applied to the guide column 7.

In order to release the locking element 21 from the guide column 7, it is initially necessary for the locking element 21 to be moved to its initial position, and then for the contact strip 18 to be pushed to its vertical initial position again, as a result of which the compression springs provided on the locking element 21, but not illustrated, and a spring element 33 provided on the contact strip 18 are preloaded. The compression springs establish the reliable active connection between the locking element 21 and the guide column 7.

In particular, FIGS. 1A, 1B and 1C show that a recovery device 31 is provided between the component 2 and the contact strip 18. The recovery device 31 in this case consists of a pull rod 32 running parallel to the movement direction of the component 2. The pull rod 32 is firmly connected to the contact strip 18. The function of the recovery device 31 is to move the contact strip 18 actively and more rapidly than the advance speed of the component 2 in the direction of the component 2. In this case, the contact strip 18 is located at a distance from the bottom edge of the component 2 in order to lock the component 2 as soon as the contact strip 18 encounters an obstacle.

FIGS. 1B and 10 show a fixed position 13 of the pull rod 32, and thus of the contact strip 18, as well as an end position 14 of the pull rod 32 and contact strip 18.

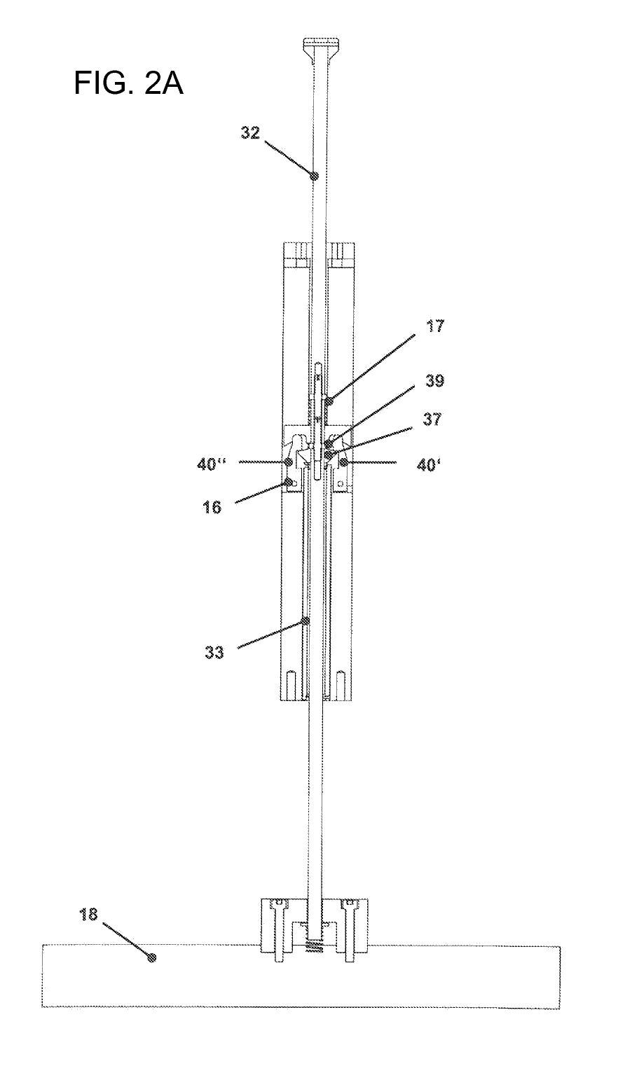

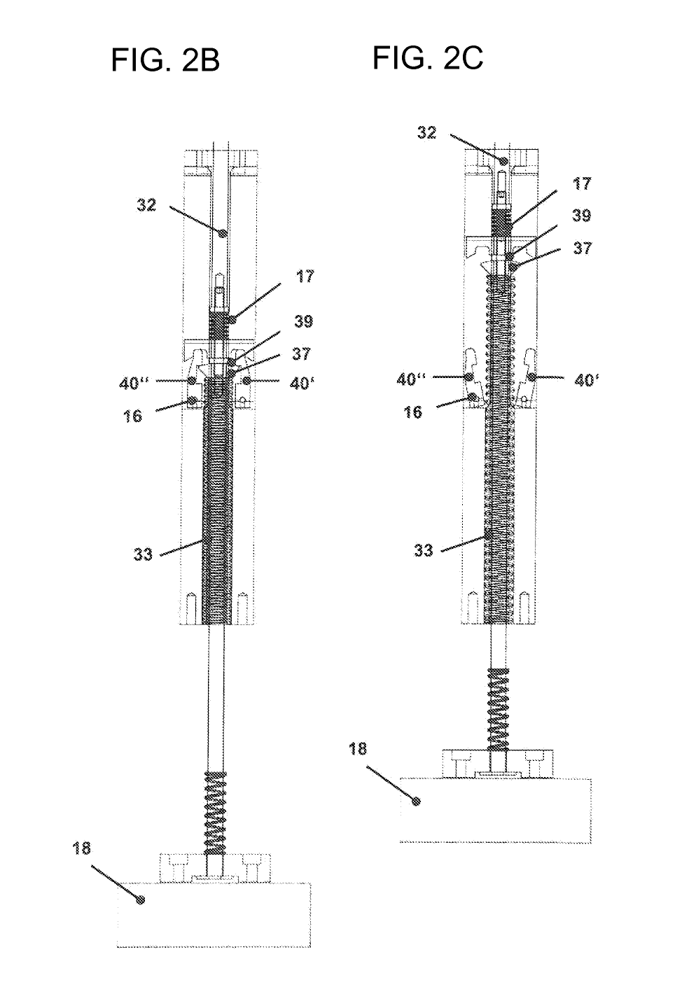

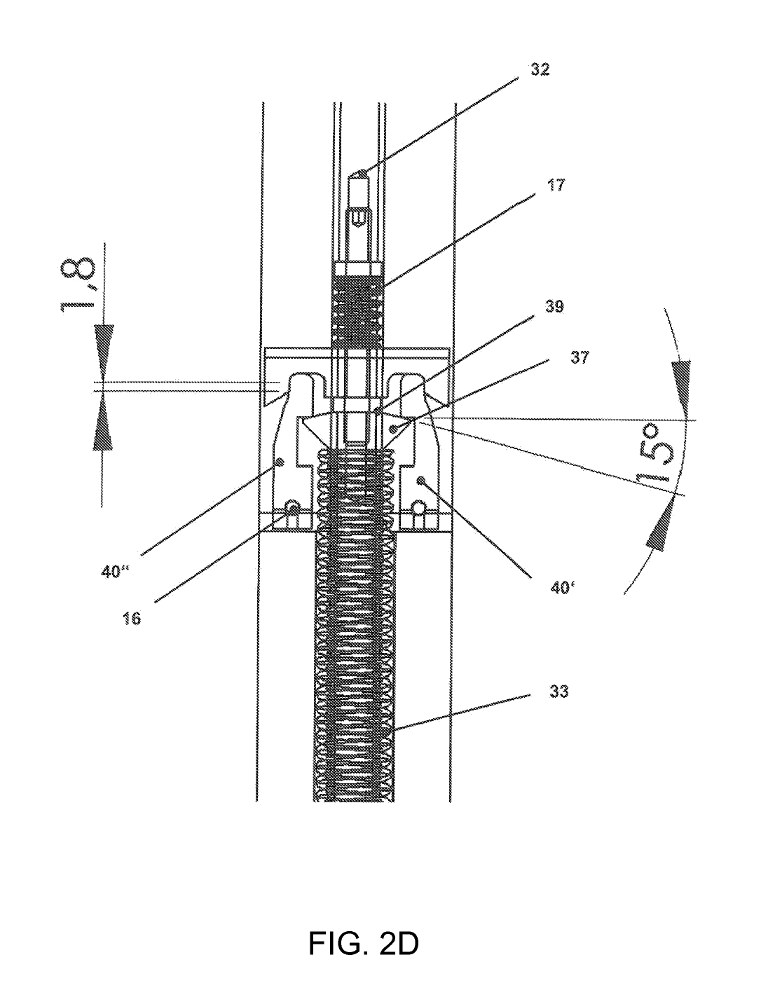

FIGS. 2A, 2B and 2C show the different movement sequences of the pull rod 32, which is moved from the fixed position 13, through a transitional position shown in FIG. 2B, to the end position 14, and as it does so draws the contact strip 18 in the direction of the component 2 in the plane formed by the component 2, i.e. in a linear direction.

FIG. 2D shows that a sliding block 37 is attached to the free end of the pull rod 32 facing away from the component 2. A coil compression spring, or the spring element, 33 is preloaded between the sliding block 37 and the bottom edge of the component.

The sliding block 37 consists of a ring surface 39 running at right angles to the axis of symmetry of the pull rod 32, in which case the ring surface 39 is located at an angle of 15° outward from the plane running perpendicular to the pull rod 32. Furthermore, a detent seat 38 is provided in the component 2, and is formed from two half-shells 40′ and 40″. The two half-shells 40′ and 40″ enclose the sliding block 37 in the manner of tongs and the internal diameter formed, or enclosed, by the half-shells 40′ and 40″ is smaller in dimension than the outer circumference of the ring surface 39 of the sliding block 37, as a result of which the pull rod 32 is secured by the half-shells 40′ and 40″ or the detent seat 38, in spite of the fact that the spring element 33 is preloaded, and thus the pull rod 32 does not move.

The two half-shells 40′ and 40″ are mounted on the component 2 by means of an articulated joint 16. Consequently, as soon as the contact strip 18 first encounters an obstacle, as shown in FIG. 2a, a force is applied to the articulated joint 16 and thus also to the half-shells 40′ and 40″, as a result of which they are swivelled outwards and open, because the ring surface 39 presses against the contact surfaces formed by the detent seat 38. As a result of the angled arrangement of the ring surface 39, the half-shells 40′ and 40″ are forced outwards and open, and the preload force of the spring element 33 causes the pull rod 32 to be moved opposite to the direction of movement of the component 2. As soon as the pull rod 32 has reached the end position 14, the movement energy of the pull rod 32 is dampened by a coil compression spring 17, as a result of which the contact strip 18 does not strike against the bottom edge of the component 2.

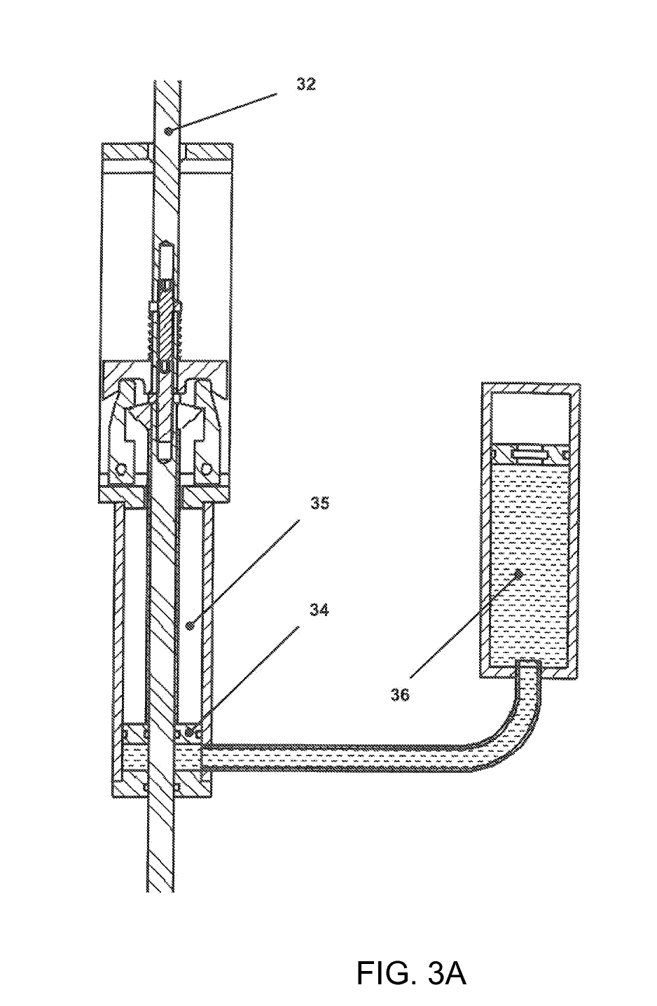

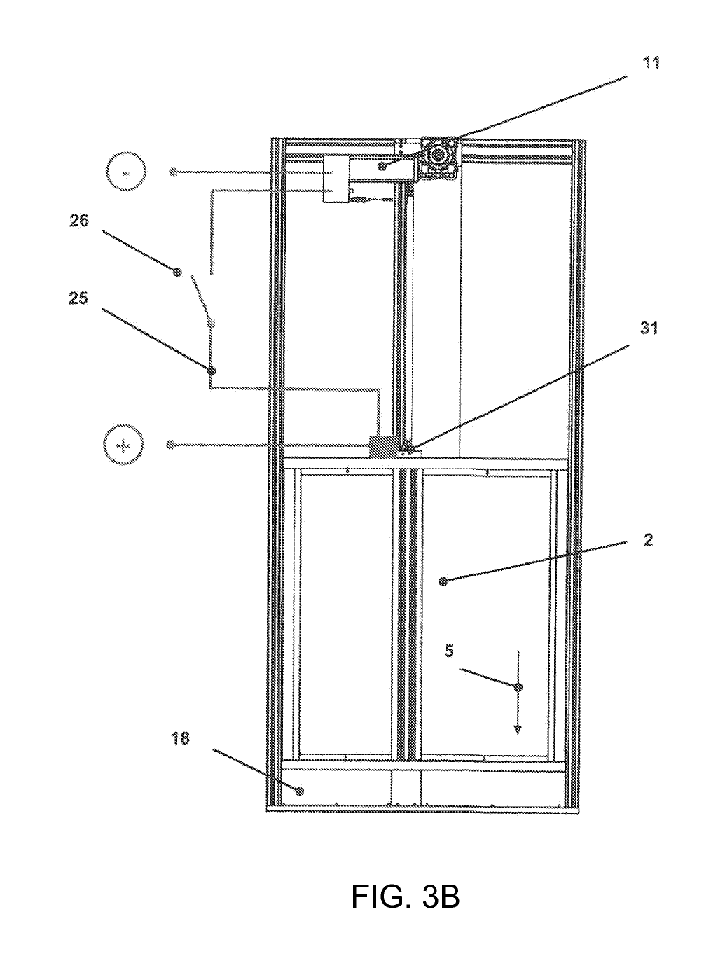

As shown in FIG. 3A, the pull rod 32 can also be activated by means of a piston 34 opposite to the movement direction of the component 2 when the contact strip 18 makes contact with an obstacle. In this case, the piston 34 is arranged in a piston space 35 containing a medium 36 under a specific pressure. As soon as the swivelling-open of the two half-shells 40′ and 40″ allows the medium 36 to escape from the piston space 35, the pull rod 32 is moved as a result of which the contact strip is also actuated.

FIG. 3B shows the electrical connection between the recovery device 31 and the servo device 11 as a schematic view. The components for locking the component 2, especially the locking element 21 and the guide column 7, are not required in this embodiment.

Rather, the component 2 is locked because when the contact strip 18 is activated, the recovery device 31 initially pulls back the contact strip 18 opposite to the movement direction of the component 2, as described in the previous figures, at a faster speed than the advance speed of the component 2, and at the same time this generates an electrical switching signal which is carried along electrical cables 25 to a switch 26. These electrical switching signals cause the switch 26 to open, as a result of which the servo device 11 is immediately electrically decoupled from a current source, and is thus blocked. The electrical cables 25 and the electrical switch 26 thus form a locking circuit that is not illustrated, by means of which the servo device 11 is separated on activation of the contact strip 18.

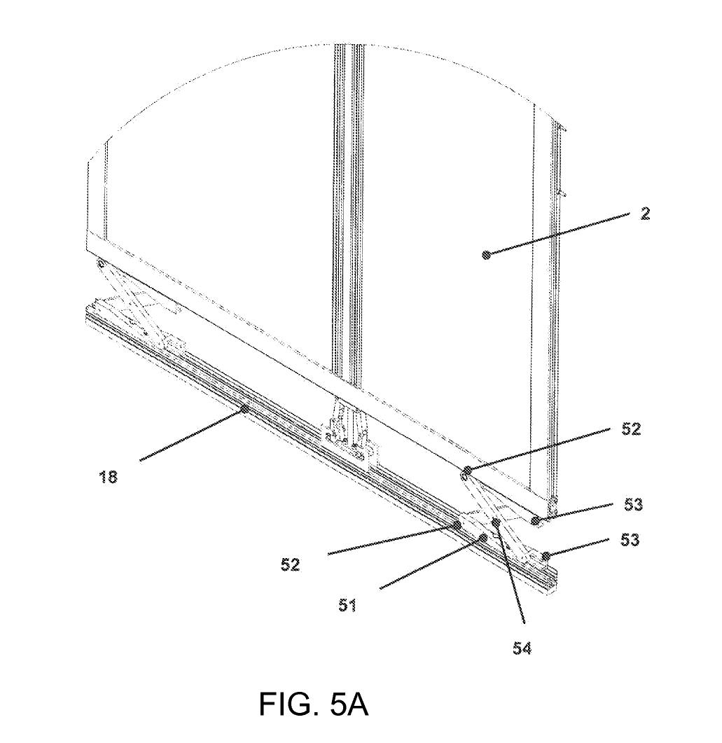

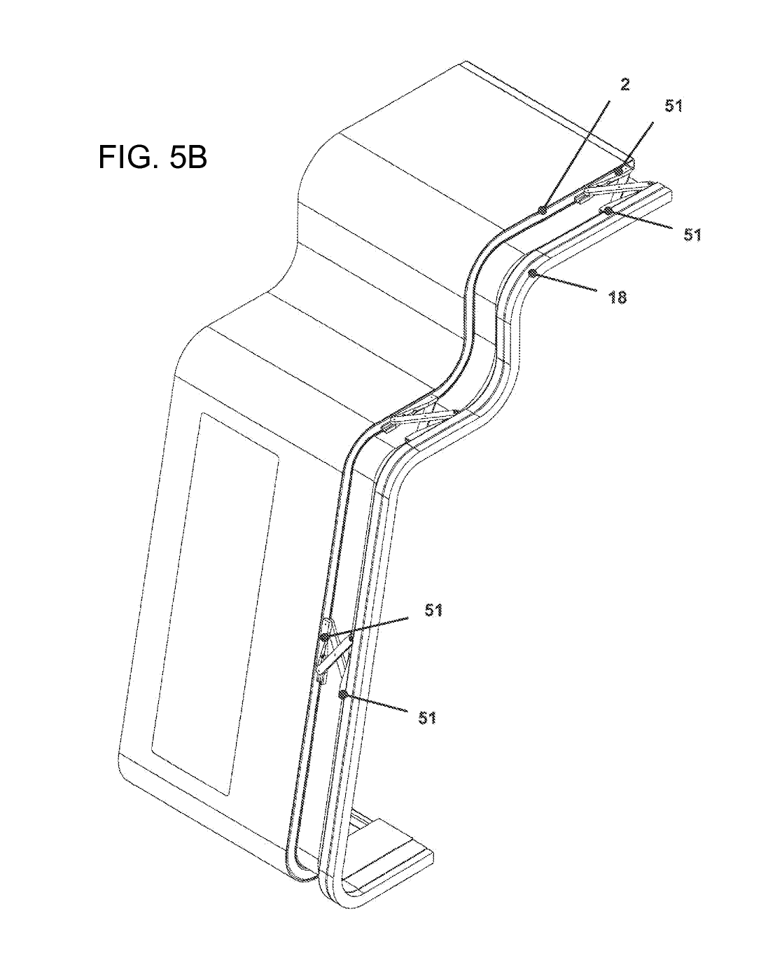

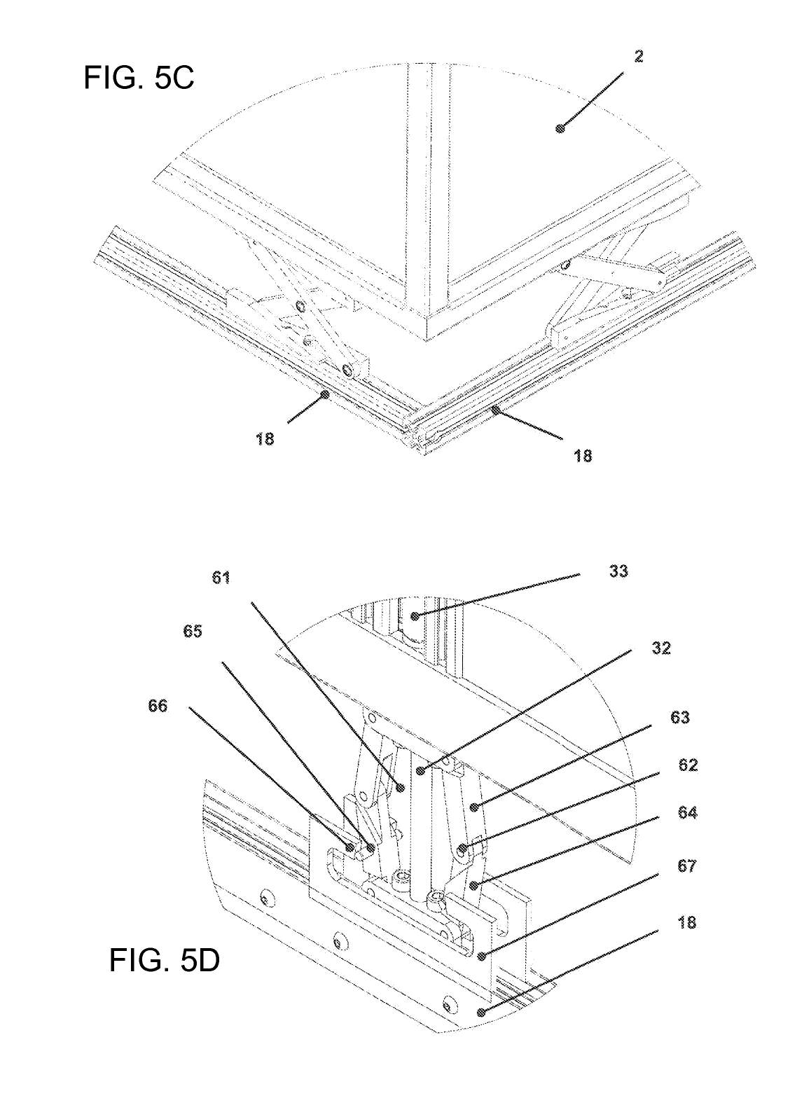

FIG. 5A shows the linear embodiment of the contact strip 18 and the bottom edge of the component 2, which are connected together via two holding arms 51 that are spaced apart and extend parallel to one another. The holding arms 51 are connected both to the component 2 and to the contact strip 18 by an articulated joint 52. Optionally, two guide arms 53 spaced apart from and running parallel to one another, each of which is connected to the corresponding holding arm 51 by means of an intersection point 54 in a scissor-type or crossways connection, can also be attached to the component 2 and to the contact strip 18 by an articulated joint 52.

The use of two holding arms 51 running parallel to, and at a distance from, one another means that there is a rotational movement of the contact strip 18 about the two connection points on the component 2, and specifically in the direction in which the holding arms 51 are aligned.

The additional attachment of the guide arms 53 gives rise to a linear movement of the contact strip 18 in the plane formed by the component 2.

FIG. 5B shows that the contour of the contact strip 18, and the bottom edge of the component 2, can be undulating in shape, because the corresponding holding arms 51 can be attached between the contact strip 18 and the component 2 such that they absorb the reliable movement of the contact strip 18 for locking the component 2.

FIG. 5C shows that the contact strips 18 can extend at right angles to one another, for example, in order to reproduce a U-shaped contour track of the component 2. In the corresponding corner areas, both contact strips 18 running adjacent to one another are locked onto one another mechanically by means of a rigid screw connection, and no rotating articulated connections are required. Irrespective of the position on the particular contact strip 18 at which an obstacle prevents the movement of component 2, this obstacle triggers activation of the recovery device 31, with the result that triggering of the contact strip 18, and thus locking of the component 2, are triggered along the entire contour track of the contact strip 18.

FIG. 5D shows that a toggle lever 61 is arranged between the contact strip 18 and the component 2. The toggle lever 61 consists of two arms that are connected together by an articulation pin 62 that is to be regarded as the intersection point for the two arms 63 and 64 forming the toggle lever 61.

The arm 63 projecting at right angles from the articulation pin 62 is connected in this case to the component 2, and the other arm 64 is connected to the contact strip 18. In addition, a pin 65 is attached to the arm 64, and the pin 65 presses against a holder 67 via an inclined plane 66, with the holder 67 in turn being attached to the contact strip 18. Pressure is built up by the compression spring 33 that is, in turn, attached to the pull rod 32.

As soon as the contact strip 18 encounters an obstacle during movement of the component 2, the trouble lever 61 is activated because it pushes the preloaded compression spring 33 upwards. The inclined plane 66 provided in the holder 67 means the compression spring 33 can be placed under a very powerful preload, resulting in a fast recovery speed. Furthermore, the inclined plane 66, combined with the pin 65, offers the advantage that, in spite of a high spring preload force, the is release force of the contact strip remains very low, as does the dynamic impact mass at high speeds.

It is also possible to equip the recovery device 31 with electric means of driving and triggering in order to move the contact strip 18 in the direction of the component 2 when encountering an obstacle. For this purpose, mechanical, or optical, sensors are attached to the underside of the contact strip 18 facing towards the movement direction, which can, for example, comprise a pressure plate, or pressure button, or a waveguide functioning as a kind of light barrier. As soon as an obstacle triggers the sensors, or interrupts their light beam, electrical switching signals actuate the electric means of driving with the effect that the pull rod 32 is moved upwards or opposite the movement direction of the component 2 by the electric means of driving, resulting in the component 2 being moved away from the obstacle.

1. A device for locking a movable component, in particular a protective or sliding door arranged in front of a working or access point to be shielded, the device comprising
two profile rails extending parallel to one another, in which the component is guided at one or both sides, and which is adapted to be adjusted by means of a servo device,
a locking element that interacts with a guide column extending parallel to the profile rails for locking the component, or a locking circuit by means of which the servo device can be deactivated,
and a contact strip attached to the component which is in a driving active connection with the locking element by mechanical connection elements, or is electrically connected to the locking circuit,
wherein,
a recovery device is disposed between the contact strip and the component, the recovery device is in a driving connection with the contact strip, such that when the contact strip makes contact with an obstacle protruding into the working or access point, the recovery device is activated by means of the resistance of the obstacle, and the contact strip is moved in a linear direction, or swivelled in the direction of the component, by the recovery device.

2. The device in accordance with claim 1,
wherein,
the recovery device comprises a pull rod and a pre-stressed spring element, comprising a coil compression spring, a preload force of which moves the pull rod out of a fixed position to an end position.

3. The device in accordance with claim 1,
wherein,
the recovery device comprises a piston, with and a piston space filled with a medium, of a gas or a fluid, that is subject to a specified internal pressure, such that when the contact strip makes contact with an obstacle, the piston actuates a pull rod that is in a driving active connection with the contact strip, and is moved or swivelled in a direction of the component by means of the pull rod and contact strip.

4. The device in accordance with claim 1,
wherein,
a recovery force of the recovery device exerted on the contact strip is of sufficient magnitude for the contact strip to be moved faster than the advance speed of the component.

5. The device in accordance with claim 3,
wherein,
a sliding block is provided on the pull rod and the sliding block is attached to a free end of the pull rod facing away from the contact strip, and the sliding block is inserted in a detent seat allocated to the component.

6. The device in accordance with claim 5,
wherein,
the sliding block is provided with a peripheral ring surface facing towards the detent seat, and the ring surface slopes outward at an angle of 10° to 20°, and preferably an angle of 15°, in relation to a plane extending perpendicularly to the pull rod.

7. The device in accordance with
wherein,
the periphery of the sliding block is larger in dimension than the internal diameter of the detent seat and that the detent seat comprises two half-shells articulated in the pull rod in a swivelling arrangement.

8. The device in accordance with claim 7,
wherein,
the half-shells of the detent seat enclose the sliding block in the manner of tongs, and that on first contact between the contact strip and an obstacle, the pull rod is lifted by 1.5 to 2 millimetres, and preferably 1.8 millimetres, and due to the actuation movement of the pull road, the two half-shells of the detent seat are swivelled open and release the sliding block.

9. The device in accordance with claim 1,
wherein,
the contact strip is arranged at a distance from the bottom edge of the component by means of two guide arms extending parallel with, but spaced apart from, one another, each of which is connected to the component and the contact strip in an articulated arrangement.

10. The device in accordance claim 9,
wherein,
the contact strip is arranged at a distance from the bottom edge of the component by means of at least two pairs of guide arms arranged crossways to one another, the pairs of guide arms being connected to the component and the contact strip in an articulated arrangement, and two guide arms and each of a pair of holding arms are arranged at a distance from one another and extend parallel to one another.

11. The device in accordance with claim 10,
wherein,
the contact strip on the component is attached by at least two holding arms articulated on the component, and the contact strip is in a movable arrangement, and the holding arms extend parallel to, and at a distance from, one another.

12. The device in accordance with claim 11,
wherein,
each of the holding arms is coupled with a guide arm in a crosswise arrangement, and the intersection point of the holding and guide arm is arranged generally in the middle between a bottom edge of the component and a top edge of the contact strip in non-actuated status.

13. The device in accordance with claim 1,
wherein,
a toggle lever is arranged between the component and the contact strip, in which case the toggle lever comprises three arms mounted in an articulation pin.

14. The device in accordance with claim 13,
wherein,
the toggle lever is coupled to a pull rod of the recovery device.

15. The device in accordance with claim 13,
wherein,
actuation of the toggle lever releases a compression spring that is under preload, and the compression spring spreads apart the two arms of the toggle lever that are articulated on the contact strip.
